(19) United States
(12) Patent Application Publication
(10) Pub. No.: US 2019/0217503 A1
(43) Pub. Date: Jul. 18, 2019

(54) METHOD FOR HEATING AN OBJECT, AND HEATING DEVICE

(71) Applicant: bielomatik Leuze GmbH + Co. KG, Neuffen (DE)

(72) Inventors: Yorck-Richard DROST, Reutlingen (DE); Christian SCHILLING, Kirchheim unter Teck (DE); Franz HEPP, Metzingen (DE); Michael JAUCH, Mossingen (DE); Hansjoerg WENZEL, Erkenbrechtsweiler (DE); Tobias BEISS, Neckartenzlingen (DE)

(73) Assignee: bielomatik Leuze GmbH + Co. KG, Neuffen (DE)

(21) Appl. No.: 16/367,416

(22) Filed: Mar. 28, 2019

Related U.S. Application Data
(63) Continuation of application No. PCT/EP2017/076103, filed on Oct. 12, 2017.

(30) Foreign Application Priority Data
Oct. 18, 2016 (DE) 10 2016 220 431.9

(51) Int. Cl. B29B 13/08; B29C 65/14; B29C 65/16; B29C 65/00; B29C 35/08

(52) U.S. Cl. CPC B29B 13/08; B29C 65/1461; B29C 65/1467; B29C 65/1661; B29C 65/1667; B29B 2013/026; B29C 66/91216; B29C 66/91221; B29C 66/961; B29C 35/0805; B29C 66/301

(57) ABSTRACT

In order to provide a method for heating an object (102) that is simple to perform and makes it possible to heat an object (102) efficiently and reliably, it is proposed that the method should include the following: providing an object (102) to be heated; applying at least one energy beam (108, 109) to the object (102) to be heated, wherein at least one energy beam (108) is guided over the object (102) to be heated multiple times, along a predetermined intended heating path (114), and this heats the object (102) along the intended heating path (114); determining a temperature distribution over the intended heating path (114), for identifying one or more deviation points (120) at which an actual local temperature differs from an expected and/or calculated temperature; changing and/or supplementing the application of at least one energy beam (108, 109) in order to compensate for the temperature difference at one or more deviation points (120).

### RELATED APPLICATION

This application is a continuation of international application No. PCT/EP2017/076103 filed on Oct. 12, 2017, and claims the benefit of German application No. 10 2016 220 431.9 filed on Oct. 18, 2016, which are incorporated herein by reference in their entirety and for all purposes.

### FIELD OF DISCLOSURE

The present invention relates to a method for heating an object, in particular for performing a plastics welding method.

### BACKGROUND

Published specifications DE 10 2005 024 983 A1 and DE 10 2008 042 663 A1 disclose different methods and devices for heating an object, in particular for performing a plastics welding method.

### SUMMARY OF THE INVENTION

The object of the present invention is to provide a method for heating an object that is simple to perform and makes it possible to heat an object efficiently and reliably.

According to the invention, this object is achieved by a method for heating an object using a heating device, wherein the method includes the following:

providing an object to be heated;
applying at least one energy beam to the object to be heated, wherein at least one energy beam is guided over the object to be heated multiple times, along a predetermined intended heating path, and this heats the object along the intended heating path;
determining a temperature distribution over the intended heating path, for identifying one or more deviation points at which an actual local temperature differs from an expected and/or calculated temperature;
changing and/or supplementing the application of at least one energy beam in order to compensate for the temperature difference at one or more deviation points.

Because, in the method according to the invention, a temperature distribution over the intended heating path is determined and is utilised to identify one or more deviation points, the application of energy can be adapted in order ultimately to ensure heating that is efficient and reliable, in particular uniform heating, of the object on the intended heating path.

The expression “changing and/or supplementing the application of the at least one energy beam” should be understood for example to mean that the at least one energy beam is itself changed, and/or that at least one further energy beam is added for the purpose of heating the object.

For example, it may be provided for the at least one energy beam to be constantly guided along the intended heating path as the main energy beam, and for any determined differences in temperature to be compensated using one or more additional energy beams.

The one or more additional energy beams preferably have a maximum power that is at most approximately 50%, for example at most approximately 20%, of a maximum power of an energy beam serving as the main energy beam.

These one or more additional energy beams are in particular directed exclusively at the one or more deviation points.

The step of determining the temperature distribution, and the step of changing and/or supplementing the application of at least one energy beam, are preferably performed once or multiple times during the heating of a single object or a plurality of objects to be heated at the same time.

In this description and the appended claims, the term “heating” should be understood in the broadest sense as the supply of heat. The heating raises the object for example locally from a low temperature level to a higher temperature level. Further, the term “heating” should preferably be understood to mean maintaining or extending a high temperature level.

The term “local” refers in particular to a section or surface of at most approximately 20%, for example at most approximately 10%, preferably at most approximately 5%, of a total section or surface of the intended heating path.

In particular, it may be provided for the term “local” to be understood to mean a section length of at most approximately 40 mm, for example at most approximately 20 mm, in particular at most approximately 10 mm.

The step of determining a temperature distribution is preferably carried out using a measuring device, in particular an infrared camera (IR camera) and/or a pyrometer.

In one embodiment of the invention, the measuring device may be capable of spatial resolution, with the result that, in particular by capture of a single image in spatially-resolved manner, the entire intended heating path or at least part of the intended heating path is detectable.

However, it may also be provided for the measuring device to take the form of a line scan camera or a point sensor. In that case, a detection region of the measuring device is in particular coupled to the motion of at least one energy beam along the intended heating path, with the result that the temperature distribution is determined by guiding a detection region of the measuring device in particular along the intended heating path.

It may be provided for the heating device first to be put in a basic mode, in which applying at least one energy beam has the effect of inputting energy uniformly along the intended heating path.

Preferably, the heating device includes at least one beam source for generating at least one energy beam, and/or a beam influencing device for influencing at least one energy beam.

The beam source and/or the beam influencing device are preferably configured to be put in different operating modes, in each case individually or together.

In the basic mode of the heating device, the beam source and/or the beam influencing device are preferably operated such that an energy density and/or a thermal power along the intended heating path is at least approximately constant.

Further, it may be provided, in dependence on the determined temperature distribution over the intended heating path, for the heating device to be put in a compensation mode, in which applying at least one energy beam brings about an energy input to one or more deviation points that is locally reduced or locally increased by comparison with an energy input to the rest of the intended heating path.

This results in particular in uniform energy input along the remaining heating path, or throughout the rest of the intended heating path.

It may be favourable if, in dependence on the determined temperature distribution over the intended heating path, the heating device is put successively in different compensation modes, in which applying at least one energy beam in a manner adapted to respectively determined local temperature differences brings about an energy input to one or more deviation points that is locally reduced or locally increased in comparison with an energy input to the rest of the intended heating path.

As a result, the formation of deviation points can preferably be continuously countered. In particular, arising deviation points can be identified at an early stage and prevented or compensated.

Preferably, the heating device is regularly put in a new compensation mode.

It may be favourable if, in the compensation mode or in a plurality of compensation modes, in dependence on a development of the temperature of the intended heating path over time, a plurality of mutually differing local temperature differences are compensated one after the other or at the same time.

Here, the expression “one after the other” should in particular be understood to mean that the compensation is undertaken in temporally successive cycles or passes by at least one energy beam.

By contrast, the expression “at the same time” should preferably be understood to mean that the compensation of a plurality of local temperature differences is carried out during the same cycle or pass.

Mutually differing local temperature differences are in particular spatially separated local temperature differences, in particular spatially separated deviation points.

It may be provided for the heating device to be operated in a compensation mode or successively in different compensation modes until an expected and/or calculated uniformity of the temperature distribution over the intended heating path has been achieved, and/or until an expected and/or calculated absolute temperature distribution over the intended heating path has been achieved.

Following this, the heating device is in particular put in basic mode or switched off.

An object that has been heated along the intended heating path using the heating device is then in particular connected to a further, preferably likewise heated, object that corresponds thereto, in particular by pressing the objects against one another along the heated intended heating paths.

Using the described method, it is thus possible in particular to perform a welding procedure, preferably a plastics welding procedure.

For the purpose of compensating for one or more local temperature differences, it is possible for example for a scanning speed of at least one energy beam to be changed locally.

The scanning speed of at least one energy beam is in particular the speed at which the at least one energy beam is guided along a beam path, in particular along the intended heating path.

The scanning speed of at least one energy beam is preferably changed locally at one or more deviation points.

It may be favourable if the scanning speed is increased locally, for example in order to pass more rapidly through a deviation point, as a result of which a quantity of heat that is introduced by at least one energy beam is reduced. This preferably allows a deviation point that has been overheated to be comparatively cooled down or at least for heating thereof to continue to a reduced extent.

Further, it may be provided for the scanning speed of at least one energy beam to be reduced at one or more deviation points. This has the effect in particular of increasing the input of heat to the one or more deviation points in order for example to heat an excessively cold deviation point to a greater extent and hence to adjust it to the temperature of the rest of the intended heating path.

Preferably, the scanning speed is varied such that the duration of a total cycle or total pass by at least one energy beam along the intended heating path remains constant over time. As a result, in particular a predetermined clock rate or operating frequency can be maintained unchanged.

It may be advantageous if, for the purpose of compensating for one or more local temperature differences, a power and/or energy density of at least one energy beam at which the at least one energy beam impinges the object is changed locally at one or more deviation points.

In this case, the power and/or energy density may in particular be increased or reduced by sharper focusing or deliberate defocusing. In particular, this allows a heating line extending along the intended heating path to become narrower or wider.

Preferably, the power and/or energy density is changed only at the one or more deviation points. In the rest of the region of the intended heating path, the at least one energy beam preferably impinges the object with a power and/or energy density that corresponds substantially to the power and/or energy density in the basic mode of the heating device.

As an alternative or in addition, for the purpose of compensating for one or more local temperature differences, it may be provided for an adapted actual beam path of at least one energy beam to be adjusted, which passes by one or more deviation points temporarily or over the long term and/or partly or entirely.

The expression “an actual beam path” should be understood in particular to mean a path along which the at least one energy beam is actually guided over the object to be heated. The actual beam path is preferably mostly, in particular at least approximately 80%, preferably at least approximately 90%, for example at least approximately 95%, identical to the intended heating path.

Preferably, the actual beam path differs from the intended heating path only in the region of one or more deviation points.

One or more deviation points are in particular “bypassed”.

The actual beam path is preferably separated from the intended heating path at a disengagement point and/or guided back to the intended heating path at an engagement point.

In the region of the disengagement point and/or in the region of the engagement point, the beam path has a radius of curvature of preferably at most approximately 15 mm, in particular at most approximately 10 mm, preferably at most approximately 2 mm.

A spacing between the disengagement point and the engagement point corresponds preferably to at most approximately twice, in particular at most approximately 1.5 times, a maximum longitudinal extent of the deviation point along the intended heating path.

When a deviation point is bypassed, a scanning speed of at least one energy beam is preferably adapted such that a total cycle time or total pass time by the at least one energy beam along the intended heating path, including bypassing the deviation point(s), is identical to a total cycle or total pass along the intended heating path with no deviation point, in particular in the basic mode of the heating device.

In one embodiment of the invention, it may be provided for
(i) a measuring device to be used to determine a development of the temperature distribution over the intended heating path over time;
(ii) a compensation mode to be identified, in particular calculated, from this for the purpose of compensating for the temperature difference at one or more deviation points; and
(iii) the heating device to be put in this compensation mode.

The steps (ii) and (iii) are preferably performed multiple times while a single object is being heated or while a plurality of objects are being heated at the same time.

Preferably, a compensation mode includes an application schema, in particular for operating the beam source and/or the beam influencing device.

In particular, a compensation mode includes an application schema for the purpose of specifying
a) an actual beam path of at least one energy beam,
b) a scanning speed characteristic of at least one energy beam,
c) a focusing characteristic of at least one energy beam, and/or
d) a power characteristic of at least one energy beam.

Here, the specification preferably relates respectively to one or more cycles or passes by at least one energy beam along the intended heating path.

For example, it may be provided for one or more deviation points to be heated to a lesser or greater extent than the rest of the intended heating path only on every second, third or fourth cycle or pass.

For example, a 25% reduction in the energy introduced is achievable if a deviation point is omitted on every fourth cycle or pass.

A 33% reduction in energy is correspondingly produced if every third cycle or pass is omitted, and so on.

It may be favourable if, for the purpose of heating the object, at least one energy beam is guided over the object, in particular along the intended heating path, at least 20 times, preferably at least 75 times, for example at least approximately 150 times.

Further, it may be favourable if the heating device, in particular the measuring device, takes a form and is set up to select or calculate an actual beam path for the purpose of bypassing one or more deviation points. In particular, as a result or in so doing, preferably a relevant section (beam path and/or deviation point) is identified.

Further, preferably a section providing an alternative route is identified, in particular avoiding undesired irradiation of components or objects to be protected in an area surrounding the object to be heated.

A scanning speed is preferably varied away from the intended heating path, in particular in order to compensate for the lengthening of the beam path that results from bypassing the deviation point. An acceleration section and/or a deceleration section of at least one energy beam along the actual beam path are preferably outside the intended heating path, such that undesired variations in the energy input along the intended heating path can be avoided or at least reduced.

In one embodiment of the invention, it may be provided for individual contours or multiple contours to be heated and/or welded. Here, an individual contour refers in particular to processing one component per side, whereas the term “multiple contours” refers to a plurality of similar components on each side.

In particular if a plurality of objects are heated at the same time, in particular using a single energy beam, it is possible to provide one or more of the following options:

It may be provided, during temporally successive cycles or passes, for at least one energy beam to leave an intended heating path on a first object at different points and/or to enter an intended heating path on a further object.

In particular, random disengagement points and engagement points may be provided on the objects. Preferably, this may allow undesired hot spots or cold spots to be prevented.

It may be provided for fixed jump paths to be provided, along which at least one energy beam is guided from one object to the next. As a result, it is preferably possible to avoid the beam source being temporarily switched off or otherwise interfered with during a cycle or pass. At the same time, this preferably makes it possible to protect objects in the surrounding area that need to be protected, in particular pneumatic lines, sensors, supply lines thereto, etc.

It may be provided for at least one energy beam to be moved between two objects at an increased scanning speed. Here, an acceleration region and/or a deceleration region preferably lie outside the intended heating paths of the objects.

It may be favourable if at least energy beam is a laser beam. In particular, all the energy beams are laser beams.

It may further be provided for one or more energy beams each to include one or more laser beams or to be formed by one or more laser beams.

Preferably, a laser wavelength is adjusted to the object to be heated, in particular the material of the object to be heated.

For example, transparent objects such as covers may be heated using a CO₂ laser, whereas in particular opaque objects such as rear casings are heated using a diode laser. Opaque objects are for example black-pigmented objects.

In particular if an intended heating path of an object is in three-dimensional form and in particular does not lie in a plane, preferably the application of at least one energy beam is adapted to the three-dimensional structure of the intended heating path.

In particular, a jump in height—that is to say a varying spacing from the intended heating path to the at least one beam source and/or to the at least one beam influencing device—is preferably compensated by varying the scanning speed and/or varying the focus of at least one energy beam and/or varying the power of at least one energy beam. Preferably, this allows uniform heating to be achieved along the intended heating path even if there are locally varying angles of incidence of the at least one energy beam on the object.

In one embodiment of the invention, it may be provided for a three-dimensional course of the intended heating path to be determined using the measuring device, and, using an object receptacle, for one or more objects that are to be heated to be oriented in relation to at least one beam influencing device and/or at least one beam source that emits at least one energy beam such that a total of the local spacings of the intended heating path from a focal plane of the at least one energy beam is minimal.

In particular if a focus of at least one energy beam is selected to be constant over time, there is preferably produced a focal plane of the at least one energy beam in which optimal and/or continuous and/or uniform heating of the object is achievable.

In dependence on the form taken by the at least one beam source and/or the at least one beam influencing device, the focal plane need not necessarily be a plane but may for example also take a curved shape, for example as a portion of a spherical surface.

By suitably orienting the one or more objects using the object receptacle, differences in height in relation to the focus may preferably be evened out.

Preferably, this allows a Rayleigh length of the optical system to be utilised.

In particular here, it may be possible to dispense with using a focusable lens.

Further, the present invention relates to a heating device for heating an object, in particular for welding plastics components.

In this respect, the object of the present invention is to provide a heating device that is of simple construction and makes it possible to heat an object reliably and efficiently.

According to the invention, this object is achieved by a heating device for heating an object, which includes the following:

at least one beam source for generating at least one energy beam and for applying it to the object;
a beam influencing device for influencing a beam direction, a beam movement, a beam intensity and/or a focus of at least one energy beam;
a measuring device for determining a temperature distribution on an intended heating path along which the object is to be heated, and for identifying one or more deviation points at which an actual local temperature measured using the measuring device differs from an expected and/or calculated temperature;
a control device for changing and/or supplementing the application of at least one energy beam in order to compensate for the temperature difference at one or more deviation points.

The heating device according to the invention preferably has individual or a plurality of the features and/or advantages described in conjunction with the method according to the invention.

The beam influencing device, the measuring device, the control device and/or the heating device overall preferably take a form and are set up to perform the method according to the invention and/or to perform individual steps of the method according to the invention.

In particular, the measuring device and/or the control device take a form and are set up (i) to determine a development of the temperature distribution over the intended heating path over time; (ii) to identify, in particular to calculate, a compensation mode for compensating for the temperature difference at one or more deviation points; and (iii) to put the heating device in this compensation mode.

In particular, the heating device is suitable for performing the method according to the invention.

Consequently, the present invention also relates to the use of a heating device, in particular a heating device according to the invention, for performing a method according to the invention.

A beam source may for example be a main beam source that generates in particular one or more energy beams that are guided or guidable along the intended heating path.

A further beam source may for example be a compensation beam source that generates in particular one or more energy beams that are directed or directable to the one or more compensation points. This in particular allows a deviation point that is too cold to be compensated.

As an alternative or in addition thereto, it may be provided for a further beam source to be a compensation beam source that generates in particular one or more energy beams that are directed or directable to the intended heating path exclusively outside of the one or more deviation points. This in particular allows a deviation point that is too hot to be compensated.

It may be provided for one or more beam sources to be used to generate energy beams of identical wavelength and/or of different wavelengths.

It may be favourable if the heating device includes one or more beam sources that take the form of and/or serve as main beam sources and, in addition, one or more beam sources that take the form of and/or serve as compensation beam sources.

Further, the method according to the invention, the heating device according to the invention and/or the use according to the invention may have individual or a plurality of the features and/or advantages described below:

It may be favourable if an intended heating path, in particular a contour of the object, is divisible or divided into sections. The measuring device and/or the beam source and/or the beam influencing device are preferably adjustable, controllable and/or regulable in accordance with these sections. In particular, separately adjusted controlling or regulating actions for the different sections are performable and/or provided.

The object to be heated is preferably brought to a target temperature in the region of the intended heating path during an initial heating phase. The initial heating phase preferably lasts for at least approximately 3 seconds, for example at least approximately 5 seconds, in particular at least approximately 6 seconds. As an alternative or in addition thereto, it may be provided for the initial heating phase to last for at most approximately 20 seconds, in particular at most approximately 15 seconds, for example at most approximately 10 seconds.

Finally, the initial heating phase is followed by a holding phase, during which a target temperature along the intended heating path is preferably maintained unchanged. The holding phase serves in particular to heat an area surrounding the intended heating path, for example in order to melt a relatively large quantity of material of the object and thus to make it available for a welding procedure.

It may be favourable if an intended heating path is detected and/or determined automatically using a measuring device.

Detection and/or determining of the intended heating path is performable in particular in the context of teaching of the contour to be heated.

It may be favourable if the object to be heated is provided with one or more markers, for example fiducial markers. These markers may in particular be integrated into a receptacle tool and/or an injection mould.

Using one or more markers, recognition of the intended heating path may in particular be made possible and/or optimised.

It may be advantageous if the heating device includes an image processing system (vision system). Using this in particular recognition of the object, preferably of the intended heating path of the object, may be automated. As an alternative or in addition thereto, detection methods and/or systems using one or more guide lasers, a speckle pattern, a stripe projection, contrasting, etc. may be provided.

It may be favourable if, for the purpose of determining the temperature distribution over the intended heating path, the measuring device is coupled to the beam source and/or the beam influencing device such that, in the event of determining an object deformation that may in particular result in a reduced width of the intended heating path and/or one or more deviation points, the intended heating path is adapted to the new shape of the object.

Further preferred features and/or advantages of the invention form the subject matter of the description below and the representation in the drawings of exemplary embodiments.

### BRIEF DESCRIPTION OF THE DRAWINGS

FIG. 1 shows a schematic illustration of a heating device for heating an object, wherein the object has been overheated at certain points and, for the purpose of compensating for the overheating, the scanning speed of an energy beam is adapted;

FIG. 2 shows a schematic illustration of an object to be heated, corresponding to FIG. 1, wherein, for the purpose of compensating for an overheated point, a power of the energy beam is varied;

FIG. 3 shows a schematic illustration of the object, corresponding to FIG. 1, wherein, for the purpose of compensating for the overheated point, a focus of the energy beam is varied;

FIG. 4 shows a schematic illustration of the object, corresponding to FIG. 1, wherein, for the purpose of compensating for the local overheating, the energy beam is guided past the overheated point at a certain point;

FIG. 5 shows a schematic perspective illustration of an object to be heated that has a substantially hexagonal intended heating path forming a closed ring, wherein a heating device for heating the object is operated in a basic mode;

FIG. 6 shows a schematic illustration of the object to be heated, corresponding to FIG. 5, wherein the heating device is first operated in a basic mode and then in a compensation mode;

FIG. 7 shows a schematic illustration of an object to be heated, corresponding to FIG. 5, wherein the heating device is operated successively first in a basic mode, then in a compensation mode, and then in the basic mode again;

FIG. 8 shows a schematic side view of an object receptacle for receiving an object to be heated, together with the object received thereon; and

FIG. 9 shows a schematic illustration, for illustrative purposes, of a course of the height of an object to be heated and the adaptation of application of the energy beam.

Like or functionally equivalent elements are provided with the same reference numerals in all Figures.

### DETAILED DESCRIPTION OF THE DRAWINGS

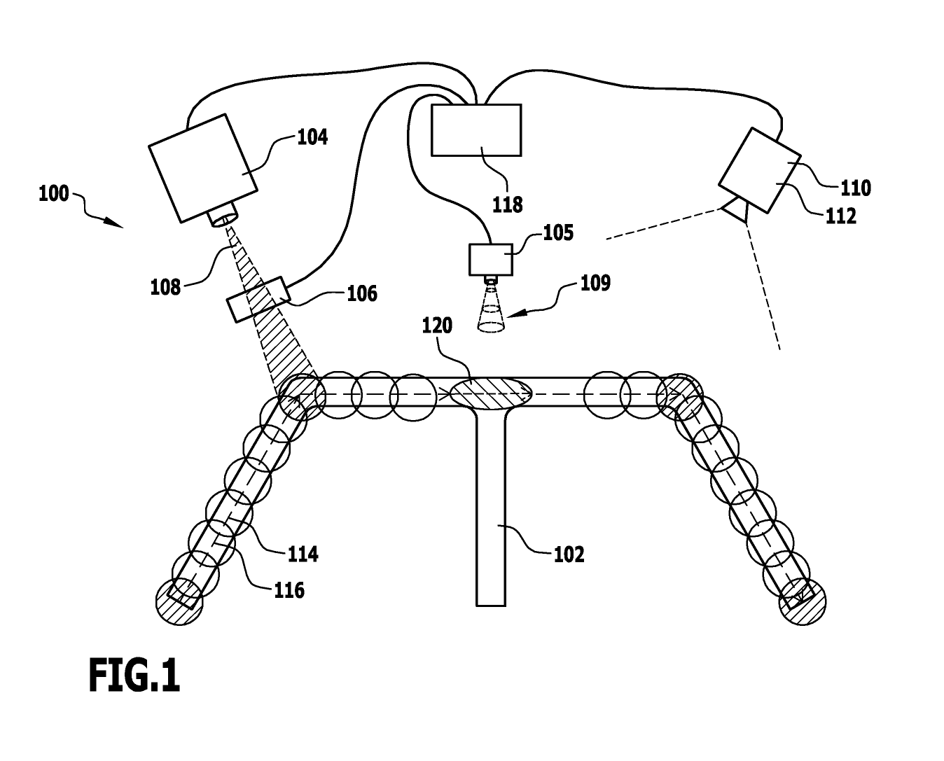

An embodiment, illustrated in FIG. 1, of a heating device that is designated 100 as a whole serves to heat an object 102, for example in order to weld this object 102 to a further object.

The object 102 is for example made from a plastics material. Consequently, the connection to be made between the two objects is in particular a plastics weld connection.

Preferably, the heating device 100 includes a beam source 104, for example a laser source.

The beam source 104 is preferably configured to generate one or more energy beams 108. The beam direction, the beam movement, the beam intensity and/or the focus of the one or more energy beams 108 are preferably influenceable and/or variable using the beam source 104. In particular, preferably a beam power of one or more energy beams 108 may be varied, preferably deliberately controlled and/or regulated, using the beam source 104. Here, the one or more energy beams 108 may for example be temporarily completely switched off, in particular for the purpose of compensating for a temperature difference at one or more deviation points 120.

Further, the heating device 100 preferably includes a beam influencing device 106, which includes in particular a deflecting device, for example a deflecting mirror, a focusing device, in particular a lens, etc.

Using the beam influencing device 106, in particular the beam direction, the beam movement, the beam intensity and/or the focus of the one or more energy beams 108 emitted by the at least one beam source 104 may be influenced and/or varied.

Further, the heating device 100 preferably includes a measuring device 110, for example a pyrometer or an infrared camera.

The measuring device 110 includes in particular a monitoring device 112, or is a constituent part of such a monitoring device 112.

Using the measuring device 110, in particular the object 102 is detectable.

Here, the measuring device 110 serves in particular to determine a temperature distribution over an intended heating path 114 along which the object 102 is to be heated using the heating device 100.

For the purpose of heating the object 102 along the intended heating path 114, the energy beam 108 is guided over the object 102 in particular along an actual beam path 116.

The beam path 116 is substantially identical to the intended heating path 114, at least in a basic mode of the heating device 100.

A control device 118 of the heating device 100 preferably serves to control and/or regulate all the further components of the heating device 100, or at least individual ones or a plurality of these components.

Using the heating device 100, the energy beam 108 is applicable to the object 102 along the intended heating path 114, preferably a plurality of times, in particular for example 200 times.

During this, the energy beam 108 is guided along the intended heating path 114, in particular in a cycle or a pass.

In particular because of material fluctuations along the intended heating path 114, this may result in heating of the object 102 that varies along the intended heating path 114.

As a result of this, deviation points 120 may in particular arise, at which an actual local temperature differs from an expected and/or calculated temperature.

Here, the difference is in particular a difference that goes beyond a predetermined limit value.

The measuring device 110 is preferably configured to detect whether individual or a plurality of deviation points 120 having a differing local temperature are produced during heating of the object 102.

As soon as the measuring device 110 detects one or more deviation points 120, preferably the control device 118 is used to act on the beam source 104 and/or the beam influencing device 106, in order to change the application of the laser beam 108.

Here, in particular a heat input by the energy beam 108 along the intended heating path 114 is varied in order ultimately to achieve, at least temporarily, a reduced heat input in overheated regions (deviation points 120), and thus to adapt the initially overheated regions, in thermal terms, to the remaining part of the intended heating path 114.

In the event of excessively cold deviation points 120, heating to a greater extent may be performed at the deviation points 120 in order ultimately to achieve an adjustment to the temperature of the rest of the intended heating path 114 in this case too.

As an alternative or in addition to varying an energy beam 108, in particular a single energy beam 108, it may be provided for a compensation energy beam 109 to be used in addition to an energy beam 108 that serves as the main energy beam, in order to compensate for one or more deviation points 120. A compensation beam source 105 is in particular configured to generate the compensation energy beam 109, which is preferably exclusively directable or directed at the one or more deviation points 120.

FIGS. 1 to 4 illustrate different variants that may respectively be utilised alone or indeed in combination with one another to compensate for the temperature difference at the deviation point 120.

According to FIG. 1, it is provided for the scanning speed at which the energy beam 108 is guided over the object 102 to be varied locally, in order ultimately to act on the deviation point 120 for a shorter period and thus to reduce the energy input. Here, the scanning speed of the energy beam 108 is preferably reduced in the remaining intended heating path 114 or throughout the rest of the intended heating path 114, such that the total cycle time or total pass time remains constant, independently of the fact of compensating for one or more temperature differences at one or more deviation points 120.

As an alternative or in addition thereto, in the embodiment illustrated in FIG. 1 one or more compensation energy beams 109 may be provided, for the purpose of compensating for one or more local temperature differences at one or more deviation points 120. In particular, this allows deviation points 120 having an excessively low temperature to be compensated, in that the one or more compensation energy beams 109 are directed at the object 102 in addition to the energy beam 108 that serves as the main energy beam.

The use of one or more compensation energy beams 109 may, as an alternative or in addition, also be provided in the case of the other described ways of compensating for deviation points 120.

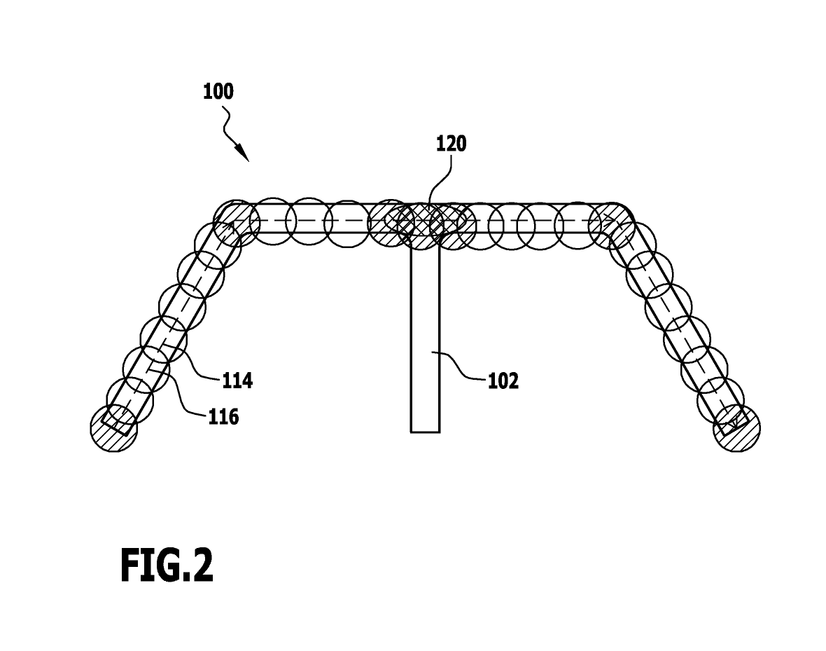

According to FIG. 2, compensation for the temperature difference at the deviation point 120 is achieved in that the power of the beam source 104 is reduced while the energy beam 108 is heating the deviation point 120.

The energy input is reduced by the reduction in power, with the result that an overheated point can in particular be adjusted, in thermal terms, to the rest of the intended heating path 114.

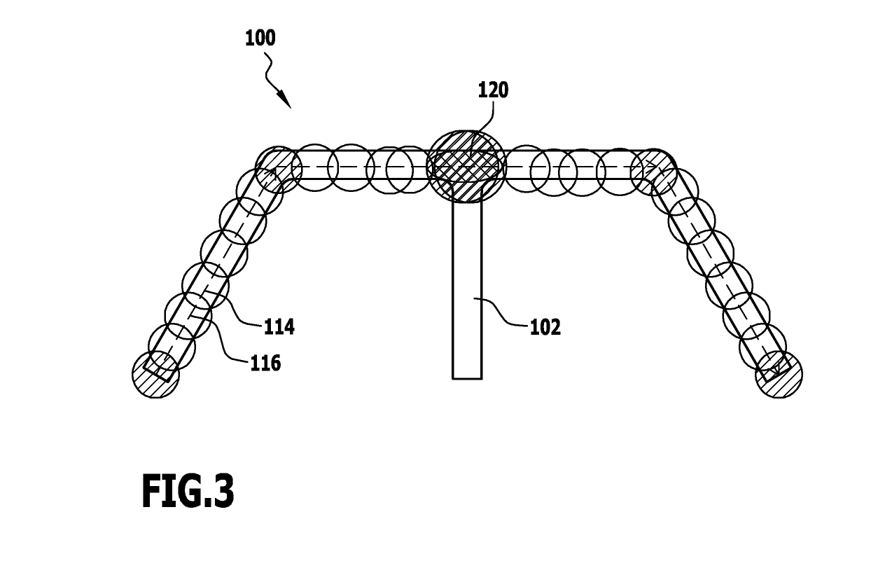

According to FIG. 3, a focus of the energy beam 108 is varied as the energy beam 108 sweeps over the deviation point 120. Here, the focus is for example changed in that a region of the object 102 that is detected by the energy beam 108 occupies for example twice, three times or four times the surface area in the region of the deviation point 120 than in the course of the rest of the intended heating path 114. In this way too, it is possible to compensate for the overheating of a point on the intended heating path 114.

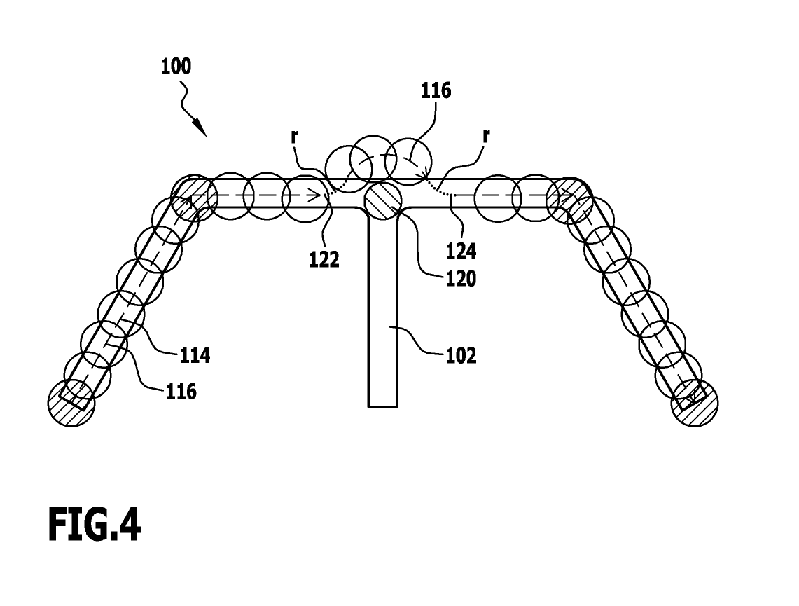

According to FIG. 4, the energy beam 108 is guided along a beam path 116 that differs locally from the intended heating path 114.

Here, the energy beam 108 is in particular moved away from the intended heating path 114 at a disengagement point 122, then guided past the deviation point 120, and finally brought back to the intended heating path 114 again at an engagement point 124.

Preferably, the disengagement point 122 and the engagement point 124 are arranged directly adjacent to the deviation point 120, such that preferably only the deviation point 120 is excluded from further overheating.

A radius of curvature r over which the energy beam 108 is guided away from the intended heating path 114 or introduced into it again is preferably at most approximately 10 mm, for example at most approximately 5 mm. It is thus preferably possible to avoid or at least reduce undesired partial cooling of the intended heating path 114 upstream and/or downstream of the deviation point 120.

As mentioned above, the options for compensating for a temperature difference at one or more deviation points 120 according to FIGS. 1 to 4 may be combined with one another in any desired way.

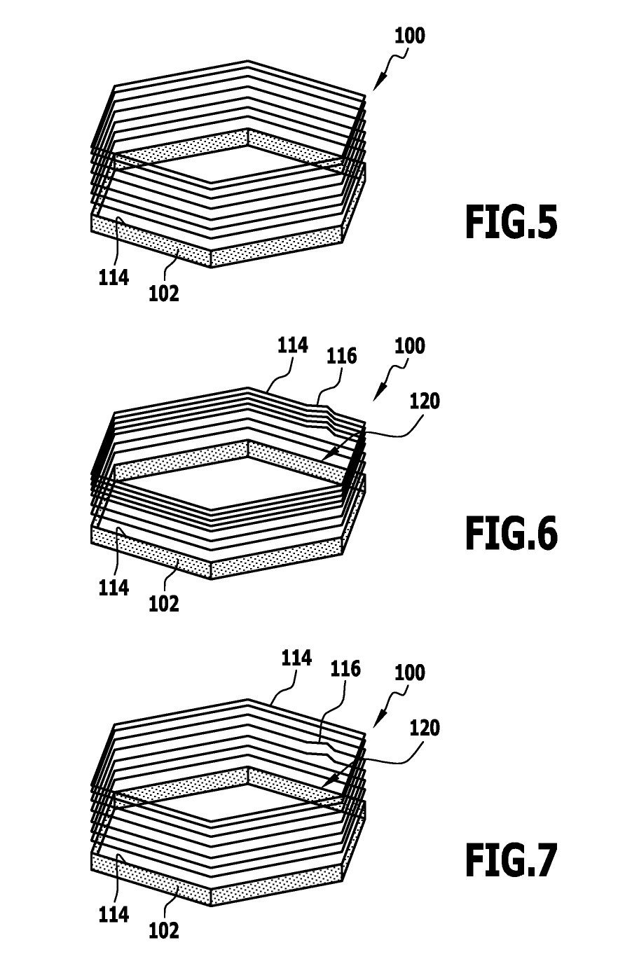

FIGS. 5 to 7 provide an alternative illustration of functioning of the heating device 100.

Here, the object 102 is illustrated.

An upper edge of the object 102 forms the intended heating path 114, which takes a form that is in particular substantially hexagonal and forms a closed ring.

The rings above this serve to illustrate how the energy beam 108 cycles over the intended heating path 114 successively over time.

As can be seen from FIG. 5, the cycles of the energy beam 108 are identical in form.

This provides a uniform application of the energy beam 108 along the intended heating path 114.

This operation of the heating device 100 is in particular a basic mode or basic operation in which uniform energy input along the intended heating path 114 is achieved.

FIG. 6, by contrast, shows a mode of operation of the heating device 100 in which initially a basic mode is provided for two cycles of the energy beam 108.

Using the measuring device 100, a deviation point 120 has for example then been detected, whereupon the control device 118 has put the heating device 100 in a compensation mode.

This compensation mode is indicated in that the cycles of the energy beam 108 in the region of the deviation point 120 take a course differing from the intended heating path 114.

In particular according to the option illustrated in FIG. 4 for compensating for a local temperature difference, in the embodiment of the compensation mode illustrated in FIG. 6 it is provided for the energy beam 108 to be guided past the deviation point 120 for a plurality of successive cycles.

This makes the temperature distribution on the intended heating path 114 uniform.

According to FIG. 7, likewise, operation is initially carried out in basic mode until the deviation point 120 is detected.

As a result of bypassing the deviation point 120 for two cycles of the energy beam 108, however, the temperature difference is rapidly brought into alignment.

The measuring device 110 detects this re-alignment and puts the heating device 100 into the basic mode again, as a result of which ultimately further uniform heating of the object 102 over the intended heating path 114 is achieved.

In particular if the object 102 to be heated has an intended heating path 114 that takes a three-dimensional shape and is not only in one plane, an initially uniform application of the energy beam 108 to the object 102 can result in a locally greatly varying temperature distribution.

In particular, local differences in height have the result that parts of the object 102 lie in a focal plane 126 of the beam source 104 and/or the beam influencing device 106 to the optimum extent, while other regions lie outside the focal plane 126 and are consequently subjected to a markedly different heat input.

Preferably, the heating device 100 includes an object receptacle 128 for receiving the object 102 to be heated.

In this case, the object receptacle 128 is in particular coupled to the control device 118 and/or the measuring device 110.

Preferably, using the measuring device 110, the intended heating path 114 over the object 102 is determinable, and using the object receptacle 128 the object 102 is orientable in the optimum manner relative to the beam source 104 and/or the beam influencing device 106.

In carrying out this orientation, it is preferably provided for a total of local spacings x₁, x₂, etc. between the intended heating path 114 and the focal plane 126 to be minimised.

In the best case, this enables varying of the focus while the object 102 is being heated to be completely dispensed with.

As an alternative or in addition to orienting the object receptacle 128 and/or the object 102 using the measuring device 110, it may for example be provided, using CAD data of the object 102, for an optimised arrangement of the object 102 to be determined, in particular calculated. Based on this, the object 102 may preferably be oriented by an optimised pivoted adjustment on the object receptacle 128.

FIG. 9 illustrates a course of the height of the intended heating path 114 relative to the beam source 104 and/or the beam influencing device 106.

As is clear from FIG. 9, where there are differences in height along the intended heating path 114, for example three regions that have to be differentiated from one another are produced.

A region I that lies closer to the beam source 104 and/or the beam influencing device 106, and a region III that lies further away from the beam source 104 and/or the beam influencing device 106.

The two regions I and III are in particular arranged such that the associated sections of the intended heating path 114 are oriented substantially parallel to one another and substantially perpendicular to a beam direction of the energy beam 108.

A rising or falling region II that lies between the regions I and III is thus oriented in particular substantially obliquely to the beam direction of the energy beam 108.

In the event of a uniform and/or continuous scanning speed of the energy beam 108, there will thus be a locally greater speed in the region II and consequently a locally smaller energy input to the object 102.

Suitably controlling and/or regulating the heating device 100 preferably has the effect of compensating for this three-dimensional contour of the object 102, in particular the course of the height of the intended heating path 114. In particular, it may be provided here for the scanning speed of the energy beam 108 to be reduced in the region II, in particular to such an extent that the local energy input corresponds to that in the regions I and III.

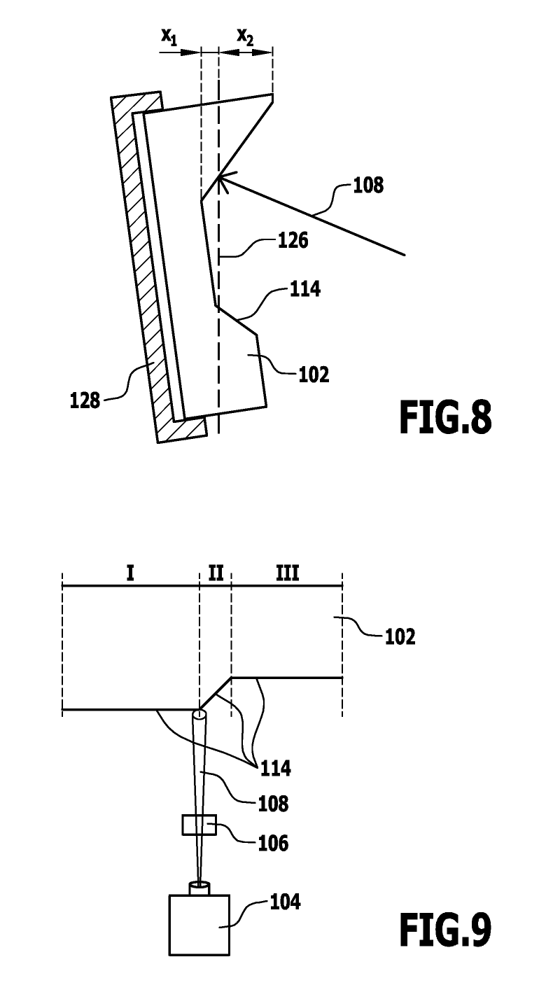

Otherwise, the embodiment of the heating device 100 that is illustrated in FIGS. 8 and 9 corresponds, as regards its structure and functioning, to the embodiment illustrated in FIG. 1, so in this respect reference is made to the description thereof above.

### LIST OF REFERENCE NUMERALS

100 Heating device
102 Object
104 Beam source
105 Compensation beam source
106 Beam influencing device
108 Energy beam
109 Compensation energy beam
110 Measuring device
112 Monitoring device
114 Intended heating path
116 Beam path
118 Control device
120 Deviation point
122 Disengagement point
124 Engagement point
126 Focal plane
128 Object receptacle
r Radius of curvature
x₁, x₂ Local spacing
I, II, III Region

1. A method for heating an object using a heating device, including the following:
providing an object to be heated;
applying at least one energy beam to the object to be heated, wherein at least one energy beam is guided over the object to be heated multiple times, along a predetermined intended heating path, and this heats the object along the intended heating path;
determining a temperature distribution over the intended heating path, for identifying one or more deviation points at which an actual local temperature differs from an expected and/or calculated temperature;
changing and/or supplementing the application of at least one energy beam (108, 109) in order to compensate for the temperature difference at one or more deviation points.

2. A method according to claim 1, wherein the heating device is first put in a basic mode, in which applying at least one energy beam has the effect of inputting energy uniformly along the intended heating path.

3. A method according to claim 1, wherein, in dependence on the determined temperature distribution over the intended heating path, the heating device is put in a compensation mode, in which applying at least one energy beam brings about an energy input to one or more deviation points that is locally reduced or locally increased in comparison with an energy input to the rest of the intended heating path.

4. A method according to claim 1, wherein, in dependence on the determined temperature distribution over the intended heating path, the heating device is put successively in different compensation modes, in which applying at least one energy beam in a manner adapted to respectively determined local temperature differences brings about an energy input to one or more deviation points that is locally reduced or locally increased in comparison with an energy input to the rest of the intended heating path.

5. A method according to claim 3, wherein, in the compensation mode or in a plurality of compensation modes, in dependence on a development of the temperature of the intended heating path over time, a plurality of mutually differing local temperature differences are compensated one after the other or at the same time.

6. A method according to claim 3, wherein the heating device is operated in a compensation mode or successively in different compensation modes until an expected and/or calculated uniformity of the temperature distribution over the intended heating path has been achieved, and/or until an expected and/or calculated absolute temperature distribution over the intended heating path has been achieved.

7. A method according to claim 1, wherein, for the purpose of compensating for one or more local temperature differences, a scanning speed of at least one energy beam at which the at least one energy beam is guided along a beam path is changed locally at one or more deviation points.

8. A method according to claim 1, wherein, for the purpose of compensating for one or more local temperature differences, a power and/or energy density of at least one energy beam with which the at least one energy beam impinges the object is changed locally at one or more deviation points.

9. A method according to claim 1, wherein, for the purpose of compensating for one or more local temperature differences, an adapted actual beam path of at least one energy beam is adjusted, which passes by one or more deviation points temporarily or over the long term and/or partly or entirely.

10. A method according to claim 1, wherein, for the purpose of compensating for one or more local temperature differences, at least one compensation energy beam is used in addition to at least one energy beam that serves as the main energy beam.

11. A method according to claim 10, wherein the at least one compensation energy beam is directed exclusively at one or more deviation points.

12. A method according to claim 1, wherein
(i) a measuring device is used to determine a development of the temperature distribution over the intended heating path over time;
(ii) a compensation mode is determined, in particular calculated, from this for the purpose of compensating for the temperature difference at one or more deviation points; and wherein
(iii) the heating device is put in this compensation mode.

13. A method according to claim 12, wherein a compensation mode includes an application schema for the purpose of specifying
a) an actual beam path of at least one energy beam,
b) a scanning speed characteristic of at least one energy beam,
c) a focusing characteristic of at least one energy beam, and/or
d) a power characteristic of at least one energy beam.

14. A method according to claim 1, wherein a spatial course of the intended heating path is determined using the measuring device, and wherein using an object receptacle, one or more objects that are to be heated are oriented in relation to at least one beam source that emits at least one energy beam and/or at least one beam influencing device such that a total of the local spacings of the intended heating path from a focal plane of at least one energy beam is minimal.

15. A heating device for heating an object, which includes the following:
a beam source for generating at least one energy beam and for applying it to the object;
a beam influencing device for influencing a beam direction, a beam movement, a beam intensity and/or a focus of at least one energy beam;
a measuring device for determining a temperature distribution on an intended heating path along which the object is to be heated, and for identifying one or more deviation points at which an actual local temperature measured using the measuring device differs from an expected and/or calculated temperature;
a control device for changing and/or supplementing the application of at least one energy beam in order to compensate for the temperature difference at one or more deviation points.

16. A heating device according to claim 15, wherein the measuring device and/or the control device take a form and are set up
(i) to determine a development of the temperature distribution over the intended heating path over time;
(ii) to determine, in particular to calculate, a compensation mode for compensating for the temperature difference at one or more deviation points; and
(iii) to put the heating device in this compensation mode.
